(19) United States
(12) Patent Application Publication
(10) Pub. No.: US 2002/0119220 A1
(43) Pub. Date: Aug. 29, 2002

(54) Reagent releasing apparatus and method

(76) Inventor: Anthony William Costello, Tauranga (NZ)

Correspondence Address: YOUNG & THOMPSON, 745 SOUTH 23RD STREET 2ND FLOOR, ARLINGTON, VA, 22202

(21) Appl. No.: 10/073,997

(22) Filed: Feb. 14, 2002

(30) Foreign Application Priority Data
Feb. 14, 2001 (NZ) 509971

(51) Int. Cl. A23B 4/00

(52) U.S. Cl. 426/111

(57) ABSTRACT

A method of reducing the amount of oxygen from prepackaged food products including the steps of placing the packaged food products within an evacuation chamber associated with a sealed container containing an oxygen absorbing reagent, evacuating gas from the evacuation chamber wherein the pressure differential in the evacuation chamber causes the sealed container to rupture thereby releasing or activating the oxygen absorbing reagent to absorb oxygen in the chamber, hermetically sealing the evacuation chamber containing the packaged food products. The gas within the sealed container may be nitrogen. The oxygen absorbing reagent may be a metal halide coated metal powder.

### FIELD OF THE INVENTION

This invention relates to product packaging technology, in particular but not limited to a method of using reagents in controlled atmosphere or vacuum packaging of food products, particularly meat.

### BACKGROUND OF THE INVENTION

Controlled atmosphere or vacuum packaging of food is well known Meat cuts are often prepared in packaging point of sale trays and covered by a film such as clear polyvinyl chloride (PVC) film. Such PVC films can be cling wrap or heat shrink films.

The trays are packed within an outer barrier bag or container and then either vacuum packed or gas flushed or both to remove air (and in particular oxygen) from the outer bag or container.

Although the outer bag is the barrier bag, the film used around each tray is a gas permeable film, and may also be perforated.

In the case of packaging meat products in such trays, the reduction in oxygen levels within the barrier bag, and within each tray is desirable in order to reduce discolouration of the meat prior to display at the point of sale.

It is therefore desirable to monitor the oxygen content within the barrier bag, or to use oxygen scavengers, or other reagents to remove as much of the residual oxygen as possible from within the bag after the application of vacuum to the bag, or after gas flushing of the bag with an inert gas, or after filling the bag with a controlled atmosphere.

However, use of reagents which react in the presence of oxygen, or reagents which can be used as oxygen scavengers, or reagents which can be used for both purposes, are difficult to use in meat packaging, as they may be consumed prior to the removal of oxygen from the outer barrier bag. Packaging of meat within such barrier bags needs to be a rapid process.

### OBJECT OF THE INVENTION

It is an object of the invention to provide an improved packaging process, or improved reagents, or which will at least provide the public with a useful choice.

In one aspect the invention provides a method of activating a reagent for use in vacuum packaging or modified atmosphere packaging of a food product, typically a meat cut, wherein at least one component of the reagent is sealed within a bag or container which can be placed within an outer barrier bag, alongside the food products, and which at least one component of the reagent can be released within the barrier bag after some or substantially all of the oxygen is removed from the barrier bag.

Preferably at least one component of the reagent is kept within a sealed bag or container which can be opened by a pressure differential between the interior of the container and the pressure within the barrier bag. Alternatively, the sealed container can be opened by some action applied to the barrier bag, for example by the application of a mechanical pressure through the surface of the barrier bag to cause the inner bag to burst, or open in some way.

Preferably the reagent is made up of at least two components, a first component sealed within a container which includes a gas trapped within the container, a second reagent preferably in the form of an absorbent pad or the like, with both the absorbent pad, and the first sealed container being held within a second larger container such as a gas permeable bag. This gas permeable bag is preferably perforated, to enable the gas within this bag to escape rapidly, as a vacuum is applied to the barrier bag

In another aspect, the invention provides a reagent system for use in the packaging of a food product, the reagent system being provided in a two or more component pack, one component reagent being provided in a sealed container which can be opened during or after the removal of atmosphere from within the confines of a barrier bag, a secondary agent in close proximity of the first reagent, with both first and secondary agents held within a gas permeable bag or the like, so that on opening of the sealed container the first reagent can mix with the secondary agent, and provide a visible indication that the reagent has been activated.

In the case where the two components of the reagent, when reacted provide an oxygen scavenger, it is also preferred that the two components include some form of visual indication, preferably a colour change, so that the extent of oxygen removal can be monitored. This is possible if the permeable bag containing the first and secondary agent is a transparent bag, and the reagents, and the food products are held within a transparent barrier bag.

In another aspect the invention provides a method of packaging of a food product such as meat, by placing the food products within a barrier bag, and placing a reagent system as described above, within the barrier bag, removing a substantial proportion of the oxygen from the barrier bag by the application of a vacuum, or a vacuum and gas flushing, or a vacuum together with gas flushing, and the insertion of a modified atmosphere into the barrier bag, to reduce the oxygen concentration within the bag to less than 600 parts per million, and then reducing the oxygen level below that, by activation of the reagent system within the barrier bag to provide an oxygen scavenger which commences work once a majority of the oxygen has been removed from the barrier bag.

### STATEMENT OF THE INVENTION

According to one aspect, the invention resides in an apparatus for releasing a reagent in a controlled atmosphere or vacuum packaging environment including in combination, a sealed container adapted to contain at least the first component of the reagent, the sealed container associated with an evacuation chamber, wherein in operation, exposure to a pressure differential or vacuum within the chamber causes the reagent to be released from the container into the chamber.

Preferably the sealed container is an enclosed pouch of an impermeable film or similar material which also contains a gas which expands as a result of a pressure differential outside of He container thereby rupturing the container to release a first component of the reagent

Preferably the reagent is activated by bringing two or more components or substances together by the return or opening of the container within a barrier bag or within a vacuum chamber. By using a film which is substantially gas impermeable, and which is not particularly stretchy, the pressure differential across the bag or container will cause it to burst. Alternatively the bag or container can be weakened, by appropriate score line, or can be made of a material which is designed to delaminated when the pressure differential exceeds a specified value.

In most cases it is preferred that the first component reagent, is released by the pressure differential across the first sealed container. However, it is possible that this opening of a sealed container can be affected by some mechanical means applied from outside of the barrier bag, or by some mechanism within a vacuum chamber. Another possibility is to use some external force, perhaps external heating which is focused on the first sealed container in such a way that the heat source does not damage the integrity of the barrier bags. One possibility might be the use of microwaves to selectively heat a liquid, perhaps a liquid reagent within a sealed container so that the gas pressure with the sealed container is such to cause the container to open. However, it is believed that the vacuum packaging step should be sufficient to cause a well-designed container to open at the required time, i.e. when the initial atmosphere within the barrier bag is substantially removed, so that there is only a small percentage of residual oxygen within the bag.

Preferably the gas is carbon dioxide, however other gases with similar properties may also be used.

Preferably the evacuation chamber is a vessel from which air can be evacuated before being hermetically sealed.

According to another aspect, the invention resides in a method of reducing oxygen from prepackaged food products including the steps of:

placing the packaged food products within an evacuation chamber associated with a sealed container containing an oxygen absorbing reagent,

evacuating gas from the evacuation chamber wherein the pressure differential in the evacuation chamber causes the sealed container to rupture thereby releasing or activating the oxygen absorbing reagent to absorb oxygen in the chamber,

hermetically sealing the evacuation chamber containing the packaged food products.

Preferably the oxygen absorbing reagent in the sealed container is a metal halide-coated metal powder with a high oxygen affinity or alternatively an equivalent oxygen absorbent composition.

Preferably there is associated with the reagent a visual indicator member adapted to indicate the activity of the reagent, for example, a colour change of the indicator can reflect the amount of oxygen absorbed by a reagent which absorbs oxygen.

### BRIEF DESCRIPTION OF THE DRAWINGS

In order that the invention may be more readily understood and put into practical effect reference will now be made to the accompanying illustrations wherein:

FIG. 1: is an illustration of a preferred embodiment of the invention according to Example 1.

FIG. 2: is an illustration of another embodiment of the invention according to Example 2.

FIG. 3: illustrates a schematic view of a number of products, typically meat in meat trays within a barrier bag.

FIG. 4: illustrates an expanded view of the reagent pack which is to be placed within the barrier bag.

### DETAILED DESCRIPTION OF THE DRAWINGS

### EXAMPLE 1

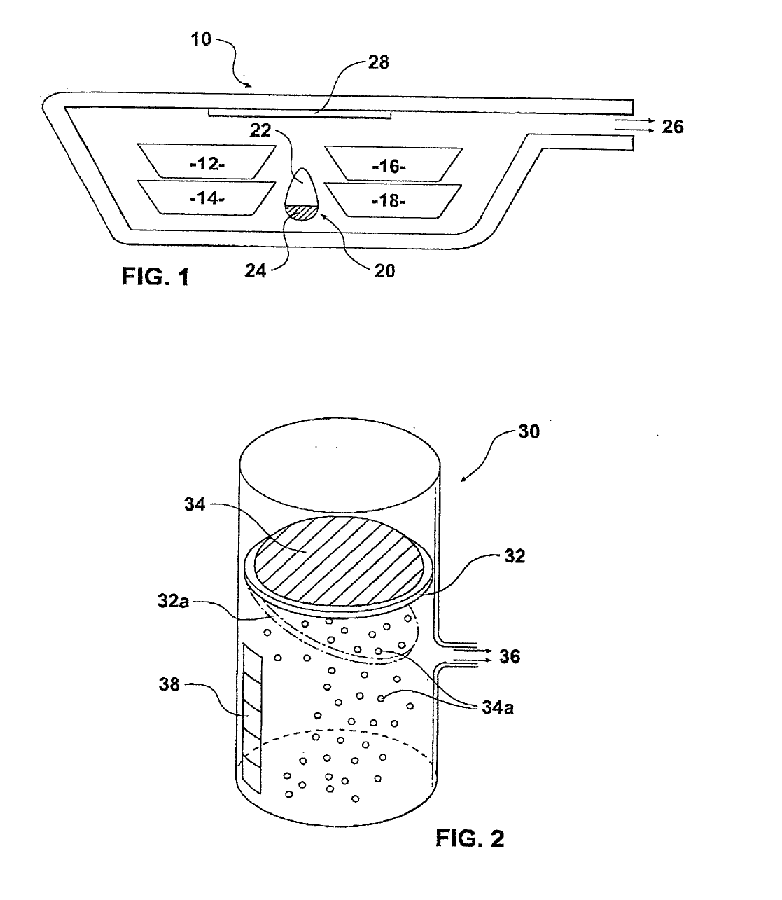

Referring now to FIG. 1 there is shown a preferred embodiment of the invention according to Example 1. There is shown an evacuation chamber 10 in which is placed shrink wrap packages 12, 14, 16, 18 of food products, typically, cuts of meat. Associated with the chamber and in the preferred example, actually introduced into the chamber is also a sealed container 20, preferably of polyethylene or similar material, containing a gas 22, typically carbon dioxide together with an oxygen absorbing reagent 24 typically a metal halide coated metal powder. As pressure is reduced in the evacuating chamber by suction or other means 26, the gas in the sealed container expands causing the container to rupture at a certain point thereby releasing the oxygen absorbing reagent into the evacuating chamber enabling oxygen within the chamber to be absorbed in the vicinity of the food packages. The reduction in the oxygen level prevents the oxidation of haemoglobin molecules in the meat thereby reducing the tendency of the meat to discolour to a grey colour typical of meat exposed to air.

Preferably there is an indicator member 28 in the form of a device of material which can change colour according to the oxygen level in the chamber as oxygen is being absorbed by the reagent.

Although typical industry standards aim to reduce the oxygen concentration to about 600 parts per million, preferably the oxygen concentration in the evacuation chamber is reduced to less than 10 parts per million which enables the meat, immediately on the completion of the oxygen removing process to retain its reddish colour and to be displayed for sale.

### EXAMPLE 2

FIG. 2 shows a perspective view of another embodiment of the invention according to Example 2. There is shown an evacuation chamber in the shape of a cylindrical drum 30, which has been compartmentalised by partition 32, A reagent composition 34 is contained behind the partition. On evacuation of air 36 from the chamber, the partition is dislodged 32a thereby spilling 34a the reagent composition into the chamber. An indicator strip 38 changes colour according to the activity level of the reagent in compartment

### EXAMPLE 3

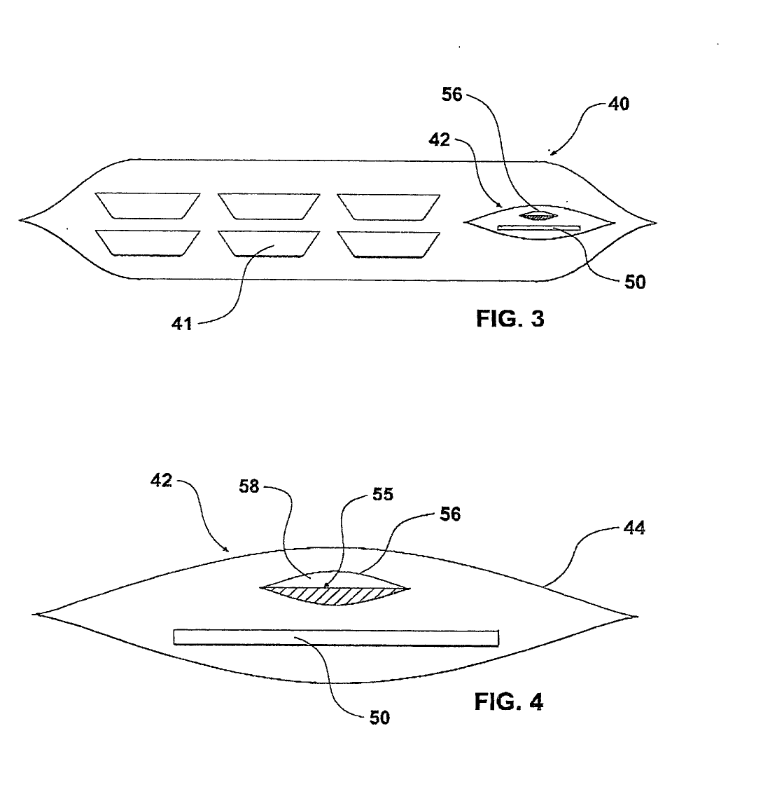

FIG. 3 shows a barrier bag 40 typically containing a series of trays 41 for products such as meat. Such trays would typically have the meat covered with a gas permeable film, typically a clear PVC film which is perforated to allow escape of gases from within each tray as a vacuum is applied to the barrier bag.

Preferably a reagent pack 42 is placed within the barrier bag prior to the vacuum step. Preferably this reagent pack 42 is within a sealed bag 44, which bag is preferably made up from a sealed clear oxygen permeable film, for example a clear PVC film This oxygen permeable bag 44 may be perforated The purpose of the bag is to contain within it a number of components. Since this bag is to placed within the outer barrier bag 40, it needs to be permeable enough that any gases within the bag 44 can be substantially removed during the vacuum phase. By sealing the bag 44, the contents can be kept clean, and preferably sterile, prior to use.

The bag 44 may remain intact during use within the barrier bag, or the bag 44 may itself be allowed to open in some way to facilitate the removal of any gas trapped within the bag 44.

Within this bag 44 is an absorbent pad 50 which contains one component of the reagent (referred to as the second component in the statement of invention). This absorbent pad 50 may be a paper pad, such as a filter paper, or the like which has been treated with one of the reagent components. More preferably this pad has a colour indicator included as part of the reagents system to show that the reagents have combined during use. By allowing the pad to change colour when the two components of the reagent are mixed together, it will be readily apparent to an observer that the reagents system is functioning Further, by providing an appropriate colour change based on the oxygen content of the bag 44 and hence the oxygen content within the barrier bag, it may be possible to monitor the performance of the reagents system, and to determine by observation the likely oxygen content of the barrier bag, and hence the estimated time between sealing of the barrier bag and the delivery of the barrier bag to a supermarket or the like.

A second reagent 55 is contained within a sealed smaller bag 56. This bag 56 is preferably a gas impermeable bag, which contains both the second component 55 of the reagent and a small quantity 58 of a gas, preferably an inert gas such as Nitrogen gas. This bag 56 is so designed that it will open once it experiences a sufficient pressure differential between the interior of the bag and the lower pressure within the barrier bag during the vacuum packaging process. As air is removed from the barrier bag 40, the pressure around the outside of bag 56 is less than the pressure of the gas sealed within it, and hence the bag 56, can be designed to open once that pressure differential exceeds a predetermined value. This can be achieved in a number of ways. By selecting the type of material, its thickness, its burst point, by weakening the bag in a number of ways, or by providing a means by which the bag can delaminated when the pressure differential exceeds a predetermined value. Since the small bag 56 is placed on top of the absorbent pad and may in fact be attached to the absorbent pad, near the centre thereof, once the smaller bag 56 is opened, the reagent component within the bag, which is preferably in the form of a liquid is allowed to escape, and intermingle with the other component of the reagent held in the absorbent pad. An outside observer can see that the inner bag 56 has opened, either by observing the change in volume of this smaller bag 56, or by noticing the delamination or bursting of the bag, or more likely by noticing that a colour change has occurred in the absorbent pad as the two components of the reagent react together to form the colour indicator, or more preferably an oxygen scavenger which has combined with it a colour change indicator.

By suitably choosing the components of the reagents system, as described above, it is believed that the oxygen content of the barrier bag can be monitored in such a way that the oxygen content can be reduced below ten parts per million (a figure which is not achievable with existing vacuum packaging or gas flushing systems) and thus the invention allows for the rapid delivery of prepackaged meat within a barrier bag to a supermarket, without the discolouration which occurs in the first few days of the packaging process with the need for speedy delivery of meat to supermarkets, it is desirable that the meat be packaged within a barrier bag with a very low oxygen content, and it is believed that this can be achieved by the method and packaging system of this example.

### Advantages

The main advantage of the invention is to enable the release of a reagent or reactive composition into a chamber which experiences a pressure differential without the need of external manipulation or operation. In the field of controlled atmosphere or vacuum packaging of food the invention enables packaged meat products to be displayed for sale immediately upon packaging without having to wait for a period for the meat to return to a reddish colour.

### Variations

Although the invention has been described with reference to a two component reagent system. It will be appreciated that it can also work with a single component reagent system, where the single component such as an oxygen scavenger is trapped within a sealed bag 56 containing an inert gas, so that the reagent is not exposed to oxygen within the bag until substantially all of the atmosphere within the bag is removed during the vacuum packaging step. However we believe it is preferable to have a two or multi component reagent system, so that the two or more components of the reagent system combine together only after the majority of the oxygen within the bag has been removed by the vacuum packaging step

Although this specification has concentrated on the opening of the inner bag 56 by the pressure differential experienced by the bag during the vacuum packaging step, it will be appreciated that the sealed bag 56 can be opened by a number of other means once the majority of the oxygen has been removed from the barrier bag. It may also be possible to seal the reagent component within the bag 56 by means of an adhesive or the like which is released during the vacuum packaging step, or which might be released by some action of the gas used for gas flushing of the barrier bag.

However, we believe that the pressure differential is the preferred means of opening the inner bag 56 and allowing the reagent components to mix together.

It will of course be realised that while the foregoing has been given by way of illustrative example of this invention, all such and other modifications and variations thereto as would be apparent to persons skilled in the art are deemed to fall within the broad scope and ambit of this invention as is herein set forth.

1. A method of providing an apparatus for releasing a reagent in a controlled atmosphere or vacuum packaging environment including in combination, a sealed bag or container adapted to contain the reagent, the sealed bag or container associated with an evacuation chamber, wherein in operation, exposure to a pressure differential or vacuum within the chamber causes the reagent to be released from the bag or container into the chamber.

2. A method as claimed in claim 1, wherein the sealed bag or container is an enclosed pouch of a film or similar material which also contains a gas which expands as a result of a pressure differential outside of the bag or container, the expansion of the gas thereby rupturing the bag or container and releasing a first component of the reagent.

3. A method as claimed in claim 1, wherein the reagent is activated by bringing two or more components or substances together by the rupturing or opening of the container within a barrier bag or within a vacuum chamber.

4. A method as claimed in claim 2, wherein the film is substantially gas impermeable, and is not particularly stretchy, so that the pressure differential across the bag or container will cause it to burst.

5. A method as claimed in claim 1, wherein the bag or container has a weakened portion, or is made of a material which is designed to delaminated when the pressure differential exceeds a specified value.

6. A method as claimed in claim 3, wherein a first component reagent, is released by the pressure differential across a first sealed container.

7. A method as claimed in claim 6, wherein the gas is an inert gas such as nitrogen.

8. A method as claimed in claim 1, wherein the evacuation chamber is a vessel from which air can be evacuated before the chamber is hermetically sealed.

9. A method as claimed in claim 1, wherein the invention resides in a method of reducing oxygen from prepackaged food products including the steps of:
placing the packaged food products within an evacuation chamber associated with a scaled container containing an oxygen absorbing reagent,
evacuating gas from the evacuation chamber wherein the pressure differential in the evacuation chamber causes the sealed container to rupture thereby releasing or activating the oxygen absorbing reagent to absorb oxygen in the chamber,
hermetically sealing the evacuation chamber containing the packaged food products.

10. A method as claimed in claim 9, wherein the oxygen absorbing reagent in the sealed container is a metal halide-coated metal powder with a high oxygen affinity or alternatively an equivalent oxygen absorbent composition.

11. A method as claimed in claim 10, wherein there is associated with the reagent a visual indicator member adapted to indicate the activity of the reagent, for example, a colour change of the indicator can reflect the amount of oxygen absorbed by a reagent which absorbs oxygen.
